(19) United States
(12) Patent Application Publication
(10) Pub. No.: US 2025/0342570 A1
(43) Pub. Date: Nov. 6, 2025

(54) MACHINE LEARNING TRAINING DATA GENERATION METHOD, MACHINE LEARNING METHOD, AND COMPUTER-READABLE RECORDING MEDIUM

(71) Applicant: OLYMPUS MEDICAL SYSTEMS CORP., Tokyo (JP)

(72) Inventor: Ken IOKA, Tokyo (JP)

(73) Assignee: OLYMPUS MEDICAL SYSTEMS CORP., Tokyo (JP)

(21) Appl. No.: 19/270,836

(22) Filed: Jul. 16, 2025

Related U.S. Application Data
(63) Continuation of application No. PCT/JP2023/022328, filed on Jun. 15, 2023.

(51) Int. Cl. G06T 5/60

(52) U.S. Cl. CPC G06T 5/60; G06T 2207/20081

(57) ABSTRACT

A machine learning training data generation method includes: acquiring a first captured image generated by a first imaging apparatus and a first subject distance regarding the first captured image; and correcting an image quality of the first captured image based on a conversion table to generate a simulation image as a machine learning training data corresponding to the first captured image defined as teaching data, the simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus.

### CROSS REFERENCES TO RELATED APPLICATIONS

This application is a continuation of International Application No. PCT/JP2023/022328, filed on Jun. 15, 2023, the entire contents of which are incorporated herein by reference.

### BACKGROUND

### 1. Technical Field

The present disclosure relates to a machine learning training data generation method, a machine learning method, and a computer-readable recording medium.

### 2. Related Art

In the related art, there has been known a super-resolution technology, being a technology that executes image quality enhancement processing on a processing target image generated by an imaging apparatus that generates a captured image with low image quality, and thereby generates an image quality enhanced inference image that seems to have been generated by an imaging apparatus that generates a captured image with high image quality (refer to JP 2018-195069 A, for example). Hereinafter, an imaging apparatus that generates a captured image with high image quality will be denoted as a first imaging apparatus, and an imaging apparatus that generates a processing target image will be denoted as a second imaging apparatus.

In the technique described in JP 2018-195069 A, image quality enhancement processing is executed on a processing target image using a trained model generated by machine learning. Here, teaching data (truth image) and training data used for generating the trained model are defined as follows.

The teaching data is a captured image (hereinafter, denoted as a first captured image) generated by the first imaging apparatus. On the other hand, the training data is a simulation image obtained by adding blur to the first captured image.

### SUMMARY

In some embodiments, a machine learning training data generation method includes: acquiring a first captured image generated by a first imaging apparatus and a first subject distance regarding the first captured image; and correcting an image quality of the first captured image based on a conversion table to generate a simulation image as a machine learning training data corresponding to the first captured image defined as teaching data, the simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus.

In some embodiments, a machine learning method includes: receiving a first captured image captured by a first imaging apparatus at a first subject distance; correcting an image quality of the first captured image by using the first captured image based on a conversion table to generate a simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus; setting a learning data set including teaching data formed with the first captured image and including training data formed with the simulation image; and performing training processing with the learning data set.

In some embodiments, provided is a non-transitory computer-readable recording medium with an executable machine learning program stored thereon. The program causes a computer to execute: receiving a first captured image captured by a first imaging apparatus at a first subject distance; correcting an image quality of the first captured image by using the first captured image based on a conversion table to generate a simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus; setting a learning data set including teaching data formed with the first captured image and including training data formed with the simulation image; and performing training processing with the learning data set.

The above and other features, advantages and technical and industrial significance of this disclosure will be better understood by reading the following detailed description of presently preferred embodiments of the disclosure, when considered in connection with the accompanying drawings.

### BRIEF DESCRIPTION

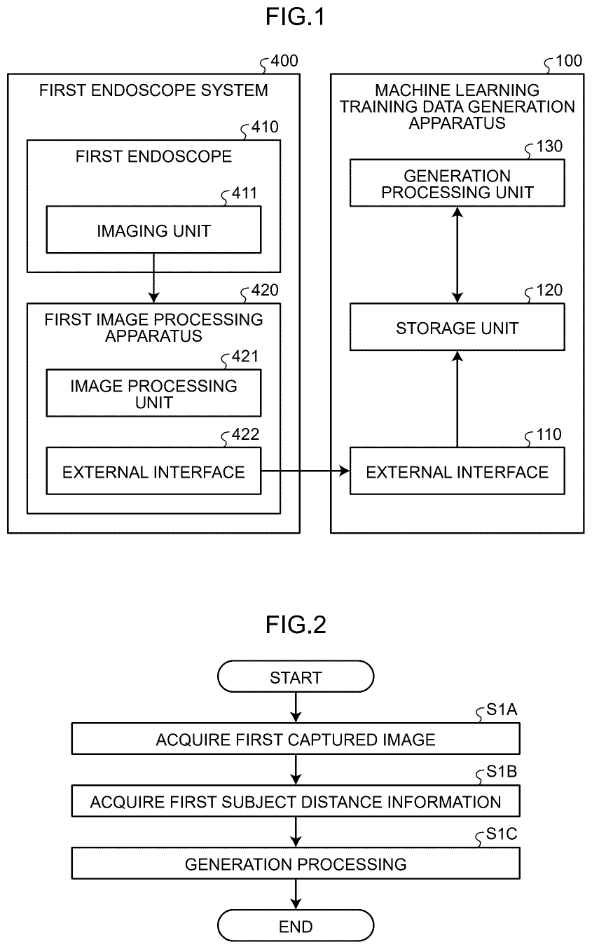

FIG. 1 is a block diagram illustrating a configuration of a machine learning training data generation apparatus according to an embodiment;

FIG. 2 is a flowchart illustrating a machine learning training data generation method;

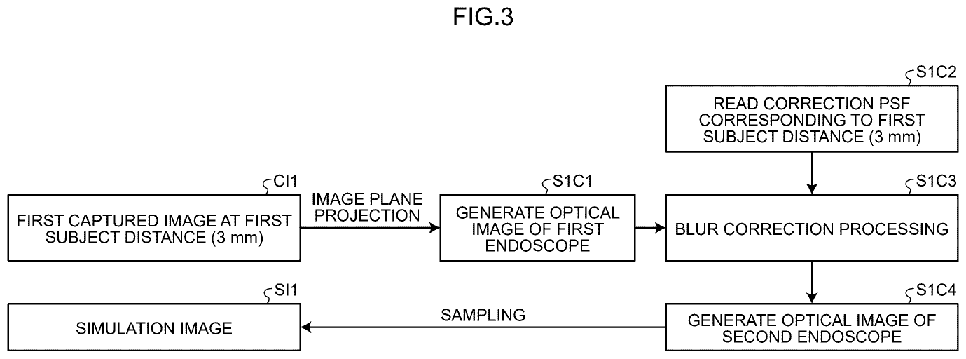

FIG. 3 is a diagram illustrating generation processing (step S1C);

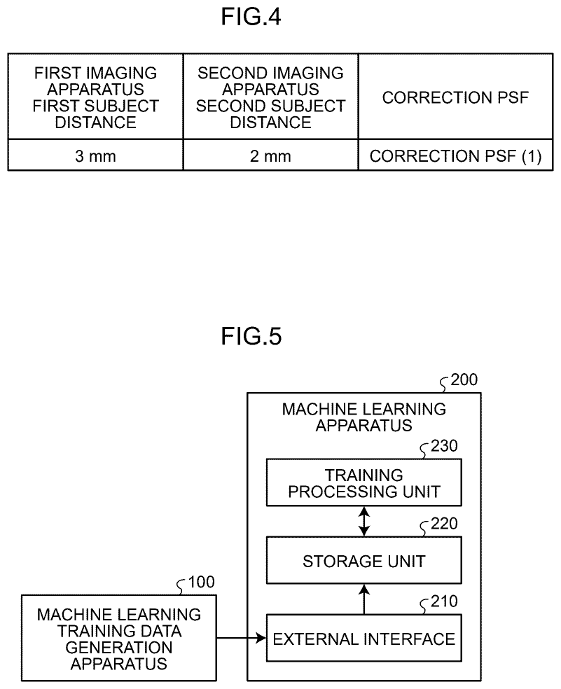

FIG. 4 is a diagram illustrating generation processing (step S1C);

FIG. 5 is a block diagram illustrating a configuration of a machine learning apparatus;

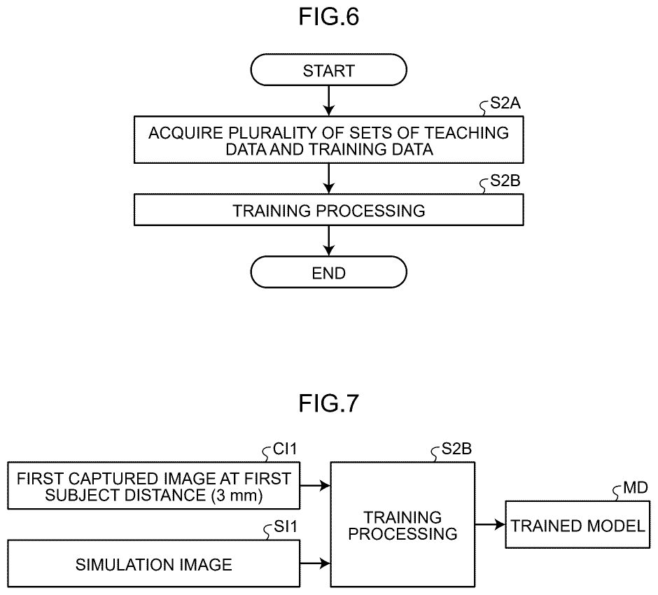

FIG. 6 is a flowchart illustrating a machine learning method;

FIG. 7 is a diagram illustrating training processing (step S2B);

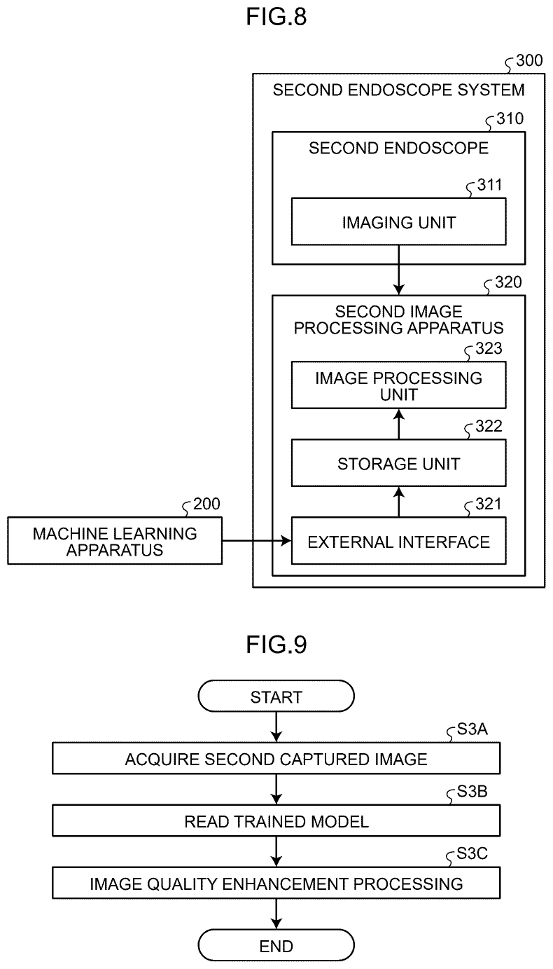

FIG. 8 is a block diagram illustrating a configuration of a second endoscope system;

FIG. 9 is a flowchart illustrating an image processing method;

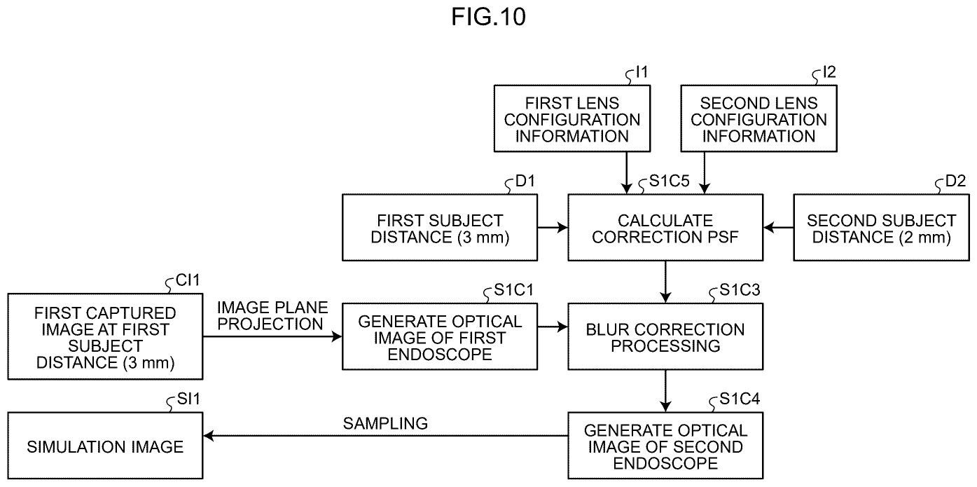

FIG. 10 is a diagram illustrating a first modification of the embodiment;

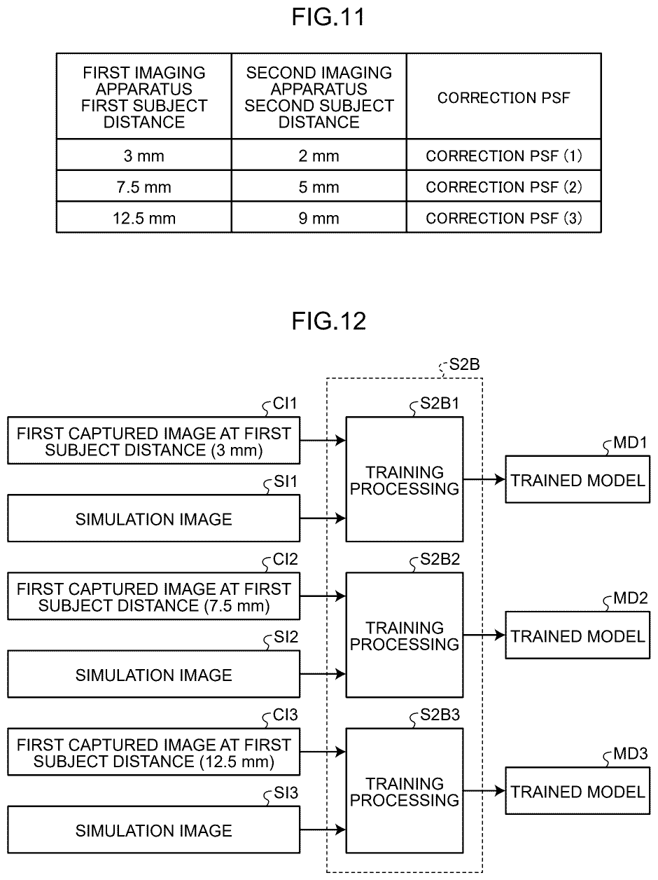

FIG. 11 is a diagram illustrating a second modification of the embodiment;

FIG. 12 is a diagram illustrating the second modification of the embodiment;

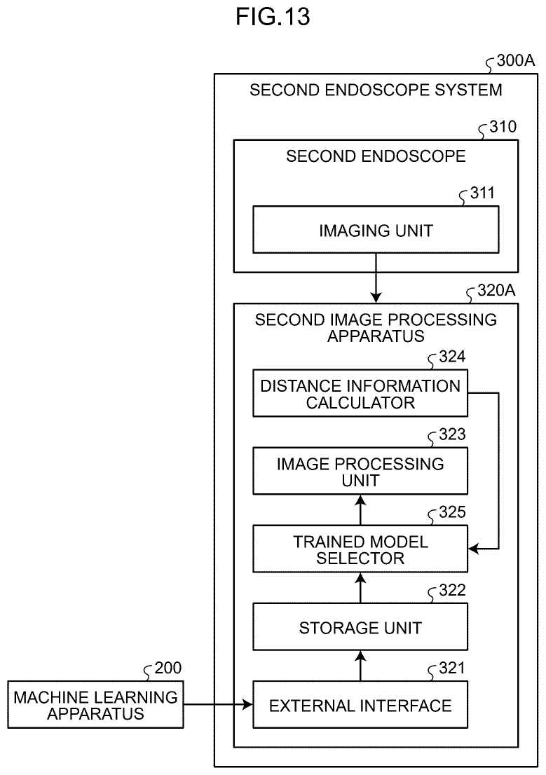

FIG. 13 is a diagram illustrating the second modification of the embodiment;

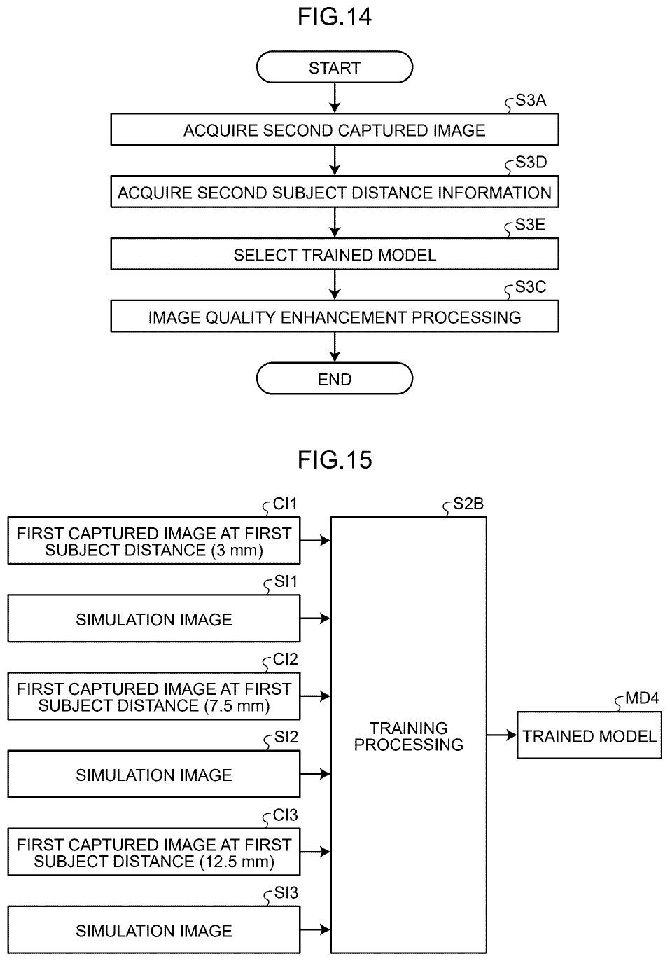

FIG. 14 is a diagram illustrating the second modification of the embodiment;

FIG. 15 is a diagram illustrating a third modification of the embodiment;

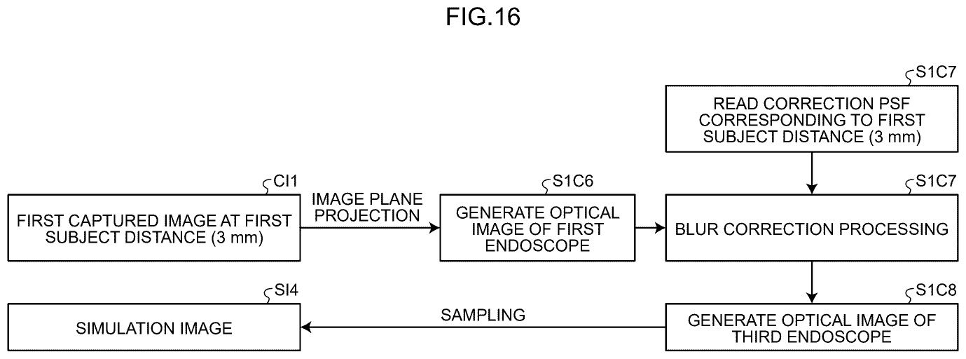

FIG. 16 is a diagram illustrating a fourth modification of the embodiment; and

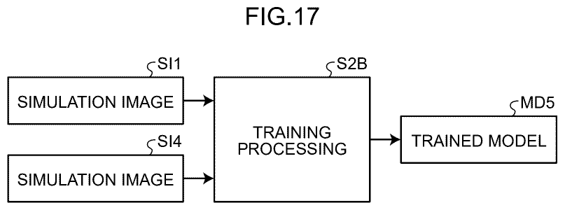

FIG. 17 is a diagram illustrating the fourth modification of the embodiment.

### DETAILED DESCRIPTION OF THE PREFERRED EMBODIMENTS

Hereinafter, a mode (hereinafter, “embodiment”) for carrying out the disclosure will be described with reference to the accompanying drawings. Note that the disclosure is not limited to embodiments described below. In the drawings, same reference signs are attached to the same components.

Hereinafter, a machine learning training data generation apparatus 100 and a generation method to generate machine learning training data, a machine learning apparatus 200 and a machine learning method to execute machine learning using the training data and generate a trained model, and a second endoscope system 300 and a method to execute image quality enhancement processing using the trained model and generate an image quality enhanced inference image will be described in order.

### Configuration of Machine Learning Training Data Generation Apparatus

First, a configuration of the machine learning training data generation apparatus 100 that generates machine learning training data will be described.

FIG. 1 is a block diagram illustrating a configuration of the machine learning training data generation apparatus 100 according to the embodiment.

The machine learning training data generation apparatus 100 is an information processing apparatus such as a personal computer (PC) or a server, and generates a simulation image to be training data necessary for generating a trained model used in image quality enhancement processing (super-resolution). Here, the machine learning training data generation apparatus 100 generates the training data from the first captured image generated by a first endoscope system 400.

Before describing the configuration of the machine learning training data generation apparatus 100, the configuration of the first endoscope system 400 will be described as below.

The first endoscope system 400 is a system used in the medical field to observe the inside of a subject (living body). As illustrated in FIG. 1, the first endoscope system 400 includes a first endoscope 410 and a first image processing apparatus 420.

The first endoscope 410 corresponds to a first imaging apparatus. The first endoscope 410 includes, for example, a flexible endoscope having an imaging unit 411 (FIG. 1) that is partially inserted into a living body and captures a subject image in the living body.

The imaging unit 411 includes an image sensor such as a Charge Coupled Device (CCD) and Complementary Metal Oxide Semiconductor (CMOS) configured to receive the subject image and convert the image into an electrical signal. Hereinafter, a captured image generated by capturing the subject image by the imaging unit 411 will be denoted as a first captured image.

The first image processing apparatus 420 includes a controller such as a central processing unit (CPU) or a micro processing unit (MPU), or an integrated circuit such as an application specific integrated circuit (ASIC) or a field-programmable gate array (FPGA), and controls the entire operation of the first endoscope system 400. As illustrated in FIG. 1, the first image processing apparatus 420 includes an image processing unit 421 and an external interface 422.

The image processing unit 421 executes predetermined image processing on the first captured image. The first captured image subjected to the image processing is displayed on a display device (not illustrated). Furthermore, the first captured image is output to the outside via the external interface 422.

As illustrated in FIG. 1, the machine learning training data generation apparatus 100 includes an external interface 110, a storage unit 120, and a generation processing unit 130.

The storage unit 120 stores the first captured image acquired via the external interface 110. While FIG. 1 illustrates a configuration in which the machine learning training data generation apparatus 100 directly acquires the first captured image from the first endoscope system 400, the acquisition of the image is not limited thereto. The machine learning training data generation apparatus 100 may be configured to acquire the first captured image output from the first endoscope system 400 and stored in a server or the like, from the server via the external interface 110.

Furthermore, the storage unit 120 stores various programs to be executed by the generation processing unit 130, information necessary for processing performed by the generation processing unit 130, and the like.

The generation processing unit 130 includes a controller such as a CPU or an MPU, or an integrated circuit such as an ASIC or an FPGA, and generates a simulation image by executing generation processing to be described below.

Detailed functions of the generation processing unit 130 will be described in the “machine learning training data generation method” described below.

### Machine Learning Training Data Generation Method

Next, a machine learning training data generation method to be executed by the machine learning training data generation apparatus 100 will be described.

FIG. 2 is a flowchart illustrating a machine learning training data generation method.

First, the generation processing unit 130 acquires the first captured image stored in the storage unit 120 (step S1A), and acquires first subject distance information indicating a first subject distance of the first captured image when the image is captured by the first endoscope 410 (step S1B).

Furthermore, it is also allowable to acquire imaging apparatus information (hereinafter, also referred to as endoscope information), being information regarding the imagine apparatus that has captured the first captured image. Examples of the imaging apparatus information include at least one of a model type and a model number of the imaging apparatus, and an optimum subject distance at which the captured endoscope is in focus. Examples of the imaging apparatus include an endoscope, a catheter with an imaging tool, and a digital camera.

The imaging apparatus information can be acquired from at least one of the types of an imaging apparatus such as an endoscope, an endoscope processor, and an image.

After the acquisition of the imaging apparatus information, there may be a case where the machine learning training data generation method is executed again using the same image or a case where the machine learning training data generation method is executed on an image or a series of images cut out from the same moving image. In this case, the acquisition of the imaging apparatus information may be omitted by using the already acquired imaging apparatus information.

Here is an assumable case where the imaging unit 411 includes a stereo camera. In this case, the generation processing unit 130 acquires, in step S1B, the first subject distance information or acquires the first subject distance information and the endoscope information as described below.

Specifically, on the image of an identical subject in each captured image (first captured image) simultaneously captured from various viewpoints by the stereo camera, the generation processing unit 130 using relative displacement amounts to calculate (acquire) the first subject distance information indicating the first subject distance based on the principle of triangulation. Here, the generation processing unit 130 calculates first subject distance information indicating the first subject distance to a subject captured in the image center of the first captured image or the first subject distance to a predetermined subject captured in the first captured image.

Furthermore, there is an assumable case where the image sensor constituting the imaging unit 411 is constituted with an image sensor including a phase shift detection pixel. In this case, the generation processing unit 130 acquires, in step S1B, the first subject distance information or acquires the first subject distance information and the endoscope information as described below.

Specifically, the generation processing unit 130 calculates (acquires) the first subject distance information indicating the first subject distance based on the pixel information corresponding to the phase shift detection pixel in the first captured image. Here, the generation processing unit 130 calculates the first subject distance information indicating the first subject distance to a subject captured in the image center of the first captured image or the first subject distance to a predetermined subject captured in the first captured image.

After step S1B, the generation processing unit 130 generates a simulation image by executing generation processing as described below (step S1C).

FIGS. 3 and 4 are diagrams illustrating generation processing (step S1C). Specifically, FIG. 4 is a diagram illustrating a correction Point Spread Function (correction PSF) stored in the storage unit 120.

In the present embodiment, based on the first subject distance information and the endoscope information acquired in step S1B, the generation processing unit 130 generates a simulation image corresponding to a case where an image of a predetermined subject distance is captured by a second endoscope having a predetermined optimum subject distance different from the value of the first endoscope. The simulation image is to be training data in machine learning.

Here, the first subject distance is 3 mm, for example. The above-described value indicating the first subject distance is merely an example, and other values may be used. Hereinafter, the above-described values will be used for convenience of description.

First, as illustrated in FIG. 3, using the first endoscope 410, the generation processing unit 130 performs image plane projection of a first captured image CI1 captured by the first endoscope 410 at an optimum subject distance with no blur, thereby generating an optical image of the first endoscope 410 (step S1C1). Specifically, the generation processing unit 130 enlarges the first captured image CI1 at a predetermined magnification in vertical/horizontal directions to generate an optical image of the first endoscope 410.

After step S1C1, as illustrated in FIG. 3, the generation processing unit 130 reads, from the storage unit 120, a correction PSF (correction PSF(1) (FIG. 4)) corresponding to the first subject distance of the first captured image CI1 (step S1C2).

Here, as illustrated in FIG. 4, the storage unit 120 stores image quality correction information (correction PSF(1)) as the correction PSF corresponding to the first subject distance (3 mm) and a second subject distance (2 mm) of a second endoscope 310 (refer to FIG. 8).

There may be case of generating a “blurred image with a subject distance of 2 mm captured by the second imaging apparatus” as learning data. In this case, simply making a correction on the first captured image with the optimum subject distance to the subject distance of 2 mm would not successfully obtain an appropriate image as learning data. Because of this, the technique, in this case, would be using a conversion table in which the degree of blurring of the first imaging apparatus and the degree of blurring of the second imaging apparatus are preliminarily associated with each other and the necessary correction PSF has been calculated. For example, the conversion table illustrated in FIG. 4 indicates that, in order to obtain a blurred image with a subject distance of 2 mm by the second imaging apparatus, there is a need to blur the image with the optimum subject distance captured by the first imaging apparatus to a subject distance of 3 mm. In other words, it can be seen that image should be blurred at 3 mm instead of 2 mm.

Where there is a plurality of conversion tables having different combinations of imaging apparatuses, a corresponding conversion table may be specified based on the above-described imaging apparatus information.

The second endoscope 310 generates a captured image lower in image quality than the first captured image. In the present embodiment, the simulation image is a simulation image being training data corresponding to teaching data (truth image) being the first captured image captured at a first subject distance (3 mm) by the first endoscope 410, and this simulation image is a simulation image simulating a second captured image captured at the second subject distance (2 mm) by the second endoscope 310. The above-described value indicating the second subject distance is merely an example, and other values may be used. Hereinafter, the above-described values will be used for convenience of description.

Meanwhile, the correction PSF(1) is calculated as follows.

An MTF1, which is the amount of blur (modulation transfer function (MTF)) on an imaging plane of the optical system constituting the first endoscope 410 at the first subject distance (3 mm), is calculated by optical simulation based on the first subject distance (3 mm) and first lens configuration information regarding the optical system.

In addition, an MTF2, which is the amount of blur (MTF) on an imaging plane of the optical system constituting the second endoscope 310 at the second subject distance (2 mm), is calculated by optical simulation based on the second subject distance (2 mm) and second lens configuration information regarding the optical system.

Correction PSF(1) is image quality correction information for correcting the amount of blurring from MTF1 to MTF2, and is constituted with a two-dimensional filter, for example.

After step S1C2, as illustrated in FIG. 3, the generation processing unit 130 performs convolution of the correction PSF(1) on the optical image generated in step S1C2 so as to correct a blur (image quality) of the optical image (first captured image) (step S1C3). With this operation, an optical image of the second endoscope 310 is generated (step S1C4).

After step S1C4, as illustrated in FIG. 3, the generation processing unit 130 performs sampling (pixel thinning) on the optical image generated in step S1C4 to generate a simulation image SI1.

Subsequently, the generation processing unit 130 stores the first captured image CI1 (teaching data) used to generate the simulation image SI1, together with the simulation image SI1 (training data), as one set in the storage unit 120.

### Configuration of Machine Learning Apparatus

Next, the following will describe a configuration of the machine learning apparatus 200 that executes machine learning using the simulation image SI1 generated by the machine learning training data generation apparatus 100 to generate a trained model.

FIG. 5 is a block diagram illustrating a configuration of the machine learning apparatus 200.

The machine learning apparatus 200 is an information processing apparatus such as a PC or a server, and executes machine learning using teaching data and training data to generate a trained model. As illustrated in FIG. 5, the machine learning apparatus 200 includes an external interface 210, a storage unit 220, and a training processing unit 230.

The storage unit 220 stores a plurality of sets of teaching data (first captured image CI1) and training data (simulation image SI1) acquired via the external interface 210. While FIG. 5 illustrates a configuration in which the machine learning apparatus 200 directly acquires a plurality of sets of teaching data (first captured image CI1) and training data (simulation image SI1) from the machine learning training data generation apparatus 100, the acquisition of data is not limited thereto. The machine learning apparatus 200 may be configured to acquire, from a server, etc. via the external interface 210, a plurality of sets of teaching data (first captured image CI1) and training data (simulation image SI1) output from the machine learning training data generation apparatus 100 and stored in the server, etc.

The storage unit 220 stores various programs to be executed by the training processing unit 230, information necessary for processing performed by the training processing unit 230, and the like.

The training processing unit 230 includes a controller such as a CPU or an MPU, or an integrated circuit such as an ASIC or an FPGA, and generates a trained model by executing training processing to be described below.

Detailed functions of the training processing unit 230 will be described in the “machine learning method” described below.

### Machine Learning Method

Next, a machine learning method to be executed by the machine learning apparatus 200 described above will be described.

FIG. 6 is a flowchart illustrating the machine learning method.

First, the training processing unit 230 acquires a plurality of sets of teaching data (first captured image CI1) and training data (simulation image SI1) stored in the storage unit 220 (step S2A).

After step S2A, the training processing unit 230 generates a trained model by executing training processing as described below (step S2B).

FIG. 7 is a diagram illustrating training processing (step S2B).

As illustrated in FIG. 7, using a plurality of sets of teaching data (first captured image CI1) and training data (simulation image SI1), the training processing unit 230 repeatedly executes training processing on the learning model and generates the learning model that has undergone the training, as a trained model MD. The learning model used for the training processing is a Convolutional Neural Network (CNN), for example. Subsequently, the training processing unit 230 calculates a weight value and a bias value of each layer of the CNN, generates the trained model MD using these values, and stores the generated trained model MD in the storage unit 220.

The neural network used in the training processing (step S1B) is not limited to the CNN, and other neural networks may be adopted. In addition, as an algorithm of machine learning in the neural network, various known learning algorithms can be adopted. For example, a supervised learning algorithm using an error back propagation method can be adopted.

### Configuration of Second Endoscope System

Next, the following will describe a configuration of the second endoscope system 300 that executes image quality enhancement processing using the trained model MD generated by the machine learning apparatus 200 and generates an image quality enhanced inference image.

FIG. 8 is a block diagram illustrating a configuration of the second endoscope system 300.

The second endoscope system 300 is a system used in the medical field to observe the inside of a subject (living body). As illustrated in FIG. 8, the second endoscope system 300 includes a second endoscope 310 and a second image processing apparatus 320.

The second endoscope 310 corresponds to the second imaging apparatus. The second endoscope 310 is configured by, for example, a flexible endoscope including an imaging unit 311 (FIG. 8) that is partially inserted into a living body and captures a subject image in the living body.

The imaging unit 311 is different from the imaging unit 411 only in generating a captured image lower in image quality than the image capture by the imaging unit 411. Hereinafter, the captured image generated by the imaging unit 311 will be denoted as a second captured image.

The second image processing apparatus 320 includes a controller such as a CPU or an MPU, or an integrated circuit such as an ASIC or an FPGA, and controls the entire operation of the second endoscope system 300. As illustrated in FIG. 8, the second image processing apparatus 320 includes an external interface 321, a storage unit 322, and an image processing unit 323.

The storage unit 322 stores the trained model MD acquired via the external interface 321. While FIG. 8 illustrates a configuration in which the second endoscope system 300 directly acquires the trained model MD from the machine learning apparatus 200, the acquisition of the model is not limited thereto. The second endoscope system 300 may be configured to acquire the trained model MD output from the machine learning apparatus 200 and stored in a server or the like, from the server via the external interface 321.

Furthermore, the storage unit 322 stores various programs to be executed by the image processing unit 323, information necessary for processing performed by the image processing unit 323, and the like.

The image processing unit 323 executes predetermined image processing on the second captured image. The second captured image subjected to the image processing is displayed on a display device (not illustrated).

Detailed functions of the image processing unit 323 will be described in “Image processing method” described below.

### Image Processing Method

Next, an image processing method executed by the second image processing apparatus 320 will be described.

FIG. 9 is a flowchart illustrating the image processing method.

First, the image processing unit 323 acquires the second captured image (step S3A) and reads the trained model MD from the storage unit 322 (step S3B). Subsequently, after step S3B, the image processing unit 323 executes image quality enhancement processing on the second captured image (processing target image) acquired in step S3A by using the trained model MD, and generates an image quality enhanced inference image (step S3C). Specifically, by executing the image quality enhancement processing on the second captured image captured by the second endoscope 310, an image quality enhanced inference image such as the first captured image CI1 captured at the first subject distance (3 mm) is generated by the first endoscope 410 which generates a captured image with a higher image quality than the second endoscope 310.

The present embodiment described above achieves the following effects.

The generation processing (step S1C) according to the present embodiment generates a simulation image simulating the second captured image captured at the second subject distance by the second endoscope 310 that generates a captured image lower in image quality than the first captured image CI1. In generating the simulation image as machine learning training data corresponding to the first captured image CI1 (teaching data), the image quality of the first captured image CI1 is corrected based on the first subject distance to generate the simulation image SI1. That is, the simulation image SI1 is generated in consideration of the first subject distance of the first captured image CI1 captured by the first endoscope 410.

Therefore, according to the present embodiment, the simulation image SI1 can be correctly generated, making it possible to generate the correct trained model MD, leading to generation of image quality enhanced inference image with high accuracy.

### Other Embodiments

While the above is description of the modes for carrying out the disclosure, the disclosure should not be limited by only the embodiments described above.

In the above-described embodiment, the following first to fourth modifications may be adopted.

### First Modification

FIG. 10 is a diagram illustrating the first modification of the embodiment. Specifically, FIG. 10 is a diagram corresponding to FIG. 3, and is a diagram illustrating the generation processing (step S1C) according to the first modification.

In the above-described embodiment, the correction PSF (correction PSF(1)) used in the blur correction processing (step S1C3) is stored in the storage unit 120, but the acquisition is the correction PSF is not limited thereto. For example, as in the first modification illustrated in FIG. 10, the correction PSF (correction PSF(1)) may be calculated before the blur correction processing (step S1C3).

Specifically, as illustrated in FIG. 10, the generation processing (step S1C) according to the first modification adopts step S1C5 instead of step S1C2.

In step S1C5, as illustrated in FIG. 10, the generation processing unit 130 performs optical simulation to calculate MTF1, which is the amount of blur (MTF) on the imaging plane of the optical system constituting the first endoscope 410 at a first subject distance (approximately 3 mm) D1 based on the first subject distance (3 mm) D1 and first lens configuration information I1 related to the optical system constituting the first endoscope 410. In addition, the generation processing unit 130 performs optical simulation to calculate MTF2, which is the amount of blur (MTF) on the imaging plane of the optical system constituting the second endoscope 310 at a second subject distance (approximately 2 mm) D2 based on the second subject distance (2 mm) D2 and second lens configuration information I2 related to the optical system constituting the second endoscope 310. Subsequently, the generation processing unit 130 calculates the correction PSF (correction PSF(1)), being image quality correction information for correcting the amount of blur, from MTF1 to MTF2. The calculated correction PSF (correction PSF(1)) is to be used in the blur correction processing (step S1C3).

Even when adopting the configuration of the first modification described above, it is possible to obtain the effects similar to those of the above-described embodiment.

### Second Modification

FIGS. 11 to 14 is a diagram illustrating a second modification of the embodiment. Specifically, FIG. 11 is a diagram corresponding to FIG. 4, and is a diagram illustrating the correction PSF stored in the storage unit 120 according to the second modification. FIG. 12 is a diagram corresponding to FIG. 7, and is a diagram illustrating training processing (step S1B) according to the second modification. FIG. 13 is a diagram corresponding to FIG. 8, and is a block diagram illustrating a configuration of a second endoscope system 300A according to the second modification. FIG. 14 is a diagram corresponding to FIG. 9, and is a flowchart illustrating an image processing method according to the second modification.

In the above-described embodiment, the machine learning training data generation apparatus 100 generates only the simulation image SI1 which is the training data corresponding to the first captured image CI1 (teaching data) having the first subject distance of 3 mm, but generation of the image is not limited thereto. For example, it is also allowable to generate a simulation image that is training data corresponding to a first captured image having the first subject distance of a value other than 3 mm.

The generation processing unit 130 according to the second modification generates: the simulation image SI1 to be training data corresponding to the first captured image CI1 in which the first subject distance based on the first subject distance information is a first specific distance; a simulation image SI2 to be training data corresponding to a first captured image CI2 in which the first subject distance is a second specific distance; and a simulation image SI3 to be training data corresponding to a first captured image CI3 in which the first subject distance is a third specific distance.

Here, the first specific distance is 3 mm similarly to the above-described embodiment. The second specific distance is 7.5 mm, for example. Furthermore, the third specific distance is 12.5 mm, for example. The above-described values indicating the first to third specific distances are merely an example, and other values may be used. Hereinafter, the above-described values will be used for convenience of description.

That is, in step S1A, the generation processing unit 130 according to the second modification acquires: the first captured image CI1 captured at the first subject distance (3 mm); the first captured image CI2 captured at the first subject distance (7.5 mm); and the first captured image CI3 captured at the first subject distance (12.5 mm).

In addition, the generation processing unit 130 according to the second modification acquires, in step S1B, first subject distance information indicating the first subject distance (3 mm), first subject distance information indicating the first subject distance (7.5 mm), and first subject distance information indicating the first subject distance (12.5 mm).

As illustrated in FIG. 11, the storage unit 120 according to the second modification stores the image quality correction information (correction PSF(1)) as the correction PSF corresponding to the first subject distance (3 mm) of the first endoscope 410 and the second subject distance (2 mm) of the second endoscope 310. In addition, the storage unit 120 stores image quality correction information (correction PSF(2)) as a correction PSF corresponding to the first subject distance (7.5 mm) of the first endoscope 410 and the second subject distance (5 mm) of the second endoscope 310. Furthermore, the storage unit 120 stores image quality correction information (correction PSF(3)) as a correction PSF corresponding to the first subject distance (12.5 mm) of the first endoscope 410 and the second subject distance (9 mm) of the second endoscope 310.

The generation processing unit 130 according to the second modification executes step S1C using the first captured image CI1 at the first subject distance (3 mm) and the correction PSF(1) to generate the simulation image SI1. The simulation image SI1 is a simulation image being training data corresponding to teaching data (truth image) being the first captured image CI1 captured at the first subject distance (3 mm) by the first endoscope 410, and this simulation image is a simulation image simulating the second captured image captured at the second subject distance (2 mm) by the second endoscope 310.

In addition, the generation processing unit 130 according to the second modification executes step S1C using the first captured image CI2 at the first subject distance (7.5 mm) and the correction PSF(2) to generate the simulation image SI2. The simulation image SI2 is a simulation image being training data corresponding to teaching data being the first captured image CI2 captured at a first subject distance (7.5 mm) by the first endoscope 410, and this simulation image is a simulation image simulating a second captured image captured at the second subject distance (5 mm) by the second endoscope 310. The above-described value indicating the second subject distance is merely an example, and other values may be used. Hereinafter, the above-described values will be used for convenience of description.

Furthermore, the generation processing unit 130 according to the second modification executes step S1C using the first captured image CI3 at the first subject distance (12.5 mm) and the correction PSF(3) to generate the simulation image SI3. The simulation image SI3 is a simulation image being training data corresponding to teaching data being the first captured image CI3 captured at a first subject distance (12.5 mm) by the first endoscope 410, and this simulation image is a simulation image simulating a second captured image captured at the second subject distance (9 mm) by the second endoscope 310. The above-described value indicating the second subject distance is merely an example, and other values may be used. Hereinafter, the above-described values will be used for convenience of description.

Subsequently, the generation processing unit 130 stores the first captured image CI1 (teaching data) used to generate the simulation image SI1, together with the simulation image SI1 (training data), as one set in the storage unit 120. The generation processing unit 130 stores the first captured image CI2 (teaching data) used to generate the simulation image SI2, together with the simulation image SI2 (training data), as one set in the storage unit 120. Furthermore, the generation processing unit 130 stores the first captured image CI3 (teaching data) used to generate the simulation image SI3, together with the simulation image SI3 (training data), as one set in the storage unit 120.

In the second modification, processing of the machine learning apparatus 200 (training processing unit 230) is also different from that of the above-described embodiment.

Specifically, as illustrated in FIG. 12, the training processing unit 230 according to the second modification repeatedly executes training processing (step S2B (step S2B1)) on the learning model using a plurality of sets of teaching data (first captured image CI1) and training data (simulation image SI1), and generates the learning model that has undergone the training, as a trained model MD1.

Moreover, as illustrated in FIG. 12, the training processing unit 230 according to the second modification repeatedly executes training processing (step S2B (step S2B2)) on the learning model using a plurality of sets of teaching data (first captured image CI2) and training data (simulation image SI2), and generates the learning model that has undergone the training, as a trained model MD2.

In addition, as illustrated in FIG. 12, the training processing unit 230 according to the second modification repeatedly executes training processing (step S2B (step S2B3)) on the learning model using a plurality of sets of teaching data (first captured image CI3) and training data (simulation image SI3), and generates the learning model that has undergone the training, as a trained model MD3.

That is, in step S2A, the training processing unit 230 according to the second modification acquires: a plurality of sets of teaching data (first captured image CI1) and training data (simulation image SI1); a plurality of sets of teaching data (first captured image CI2) and training data (simulation image SI2); and a plurality of sets of teaching data (first captured image CI3) and training data (simulation image SI3).

Subsequently, the training processing unit 230 according to the second modification stores the generated trained model MD1 in the storage unit 220 in association with the second subject distance (2 mm). Furthermore, the training processing unit 230 stores the generated trained model MD2 in the storage unit 220 in association with the second subject distance (5 mm). Furthermore, the training processing unit 230 stores the generated trained model MD3 in the storage unit 220 in association with the second subject distance (9 mm).

In the second modification, the configuration of the second endoscope system 300A is also different from the configuration of the second endoscope system 300 described in the above-described embodiment.

Specifically, as illustrated in FIG. 13, the second endoscope system 300A according to the second modification is different from the second endoscope system 300 in the configuration of the second image processing apparatus 320. Hereinafter, the second image processing apparatus 320 according to the second modification will be denoted as a second image processing apparatus 320A.

The second image processing apparatus 320A corresponds to an image processing apparatus. As illustrated in FIG. 13, the second image processing apparatus 320A has additional functions of a distance information calculator 324 and a trained model selector 325, as compared with the second image processing apparatus 320.

Hereinafter, the functions of the distance information calculator 324 and the trained model selector 325 will be described along with the description of the image processing method according to the second modification.

As illustrated in FIG. 14, the image processing method according to the second modification has additional steps, namely, steps S3D and S3E instead of step S3B, compared with the image processing method described in the above-described embodiment.

Step S3D is executed after step S3A.

Specifically, in step S3D, the distance information calculator 324 acquires second subject distance information indicating the second subject distance of the second captured image acquired in step S3A.

Here is an assumable case where the imaging unit 311 includes a stereo camera. In this case, in step S3D, the distance information calculator 324 acquires the second subject distance information as follows.

Specifically, on the image of an identical subject in each captured image (second captured image) simultaneously captured from different viewpoints by the stereo camera, the distance information calculator 324 uses relative displacement amounts to calculate (acquire) the second subject distance information indicating the second subject distance based on the principle of triangulation. Here, the distance information calculator 324 calculates second subject distance information indicating either the second subject distance to a subject captured in the image center of the second captured image or the second subject distance to a predetermined subject captured in the second captured image.

Furthermore, there is an assumable case where the image sensor constituting the imaging unit 311 is constituted with an image sensor including a phase shift detection pixel. In this case, in step S3D, the distance information calculator 324 acquires the second subject distance information as follows.

Specifically, the distance information calculator 324 calculates (acquires) the second subject distance information indicating the second subject distance based on the pixel information corresponding to the phase shift detection pixel in the second captured image. Here, the distance information calculator 324 calculates second subject distance information indicating either the second subject distance to a subject captured in the image center of the second captured image or the second subject distance to a predetermined subject captured in the second captured image.

After step S3D, from among the trained models MD1 to MD3 stored in the storage unit 322, the trained model selector 325 selects a trained model corresponding to the second subject distance based on the second subject distance information acquired in step S3D (step S3E). Subsequently, the image quality enhancement processing in step S3C uses the trained model selected in step S3E. Specifically, by executing the image quality enhancement processing on the second captured image captured by the second endoscope 310, an image quality enhanced inference image such as the first captured image CI1 captured at the first subject distance at an optimum subject distance is generated by the first endoscope 410 which generates a captured image with a higher image quality than the second endoscope 310. In this case, for example, while the machine learning applies the image quality enhancement target image to the learning model trained to bring the image with the subject distance of 2 mm to the optimum subject distance, the target image does not need to be the image having the subject distance of 2 mm. In this case, for example, even an image having a subject distance of 1 mm to 3 mm can undergo image quality conversion to obtain an image having the optimum subject distance. In other words, with the machine learning model, it is also possible to perform image quality enhancement on even a blurred image having a subject distance different ±1.5 mm, for example, from the subject distance in the learning image used at the time of machine learning.

In addition, by executing the image quality enhancement processing on the second captured image captured at the second subject distance (substantially 5 mm) by the second endoscope 310, an image quality enhanced inference image such as the first captured image CI2 captured at the optimum subject distance is generated by the first endoscope 410 which generates a captured image with a higher image quality than the second endoscope 310. In addition, by executing the image quality enhancement processing on the second captured image captured at the second subject distance (substantially 9 mm) by the second endoscope 310, an image quality enhanced inference image such as the first captured image CI3 captured at the optimum subject distance is generated by the first endoscope 410 which generates a captured image with a higher image quality than the second endoscope 310.

Even when adopting the configuration of the second modification described above, it is possible to obtain the effects similar to those of the above-described embodiment.

In the second modification, for each of the first captured images CI1 to CI3 having mutually different first subject distances, the simulation images SI1 to SI3 are respectively generated based on the first subject distances. In addition, the trained models MD1 to MD3 are generated by machine learning individually for the set of the first captured image CI1 (teaching data) and the simulation image SI1 (training data), the set of the first captured image CI2 (teaching data) and the simulation image SI2 (training data), and the set of the first captured image CI3 (teaching data) and the simulation image SI3 (training data). Subsequently, among the trained models MD1 to MD3, the image quality enhancement processing is executed on the second captured image by using the trained model corresponding to the second subject distance of the second captured image captured by the second endoscope 310 to generate the image quality enhanced inference image.

Accordingly, even in a case where the second endoscope 310 generates the second captured image at various second subject distances, it is possible to generate the image quality enhanced inference image with high accuracy from the second captured image using the trained model corresponding to the second subject distance.

### Third Modification

FIG. 15 is a diagram illustrating a third modification of the embodiment. Specifically, FIG. 15 is a diagram corresponding to FIG. 12, and is a diagram illustrating training processing (step S1B) according to the third modification.

In the second modification described above, the trained models MD1 to MD3 are generated by machine learning from a plurality of sets of teaching data (first captured image CI1) and training data (simulation image SI1), a plurality of sets of teaching data (first captured image CI2) and training data (simulation image SI2), and a plurality of sets of teaching data (first captured image CI3) and training data (simulation image SI3). However, generation of the trained model is not limited thereto.

As illustrated in FIG. 15, in step S2B, the training processing unit 230 according to the third modification repeatedly executes training processing for an identical learning model using a plurality of sets of teaching data (first captured image CI1) and training data (simulation image SI1), a plurality of sets of teaching data (first captured image CI2) and training data (simulation image SI2), and a plurality of sets of teaching data (first captured image CI3) and training data (simulation image SI3), and generates a learning model that has undergone the training, as a trained model MD4. The trained model MD4 corresponds to a third trained model.

The image processing method according to the third modification is similar to the above-described embodiment except that the trained model MD4 is used as a modification from the trained model MD. Specifically, also in the third modification, similarly to the above second modification, by executing the image quality enhancement processing on the second captured image captured by the second endoscope 310, an image quality enhanced inference image such as the first captured image CI1 captured at the first subject distance at an optimum subject distance is generated by the first endoscope 410 which generates a captured image with a higher image quality than the second endoscope 310. In this case, for example, while the machine learning applies the image quality enhancement target image to the learning model trained to bring the image with the subject distance of 2 mm to the optimum subject distance, the target image does not need to be the image having the subject distance of 2 mm. In this case, for example, even an image having a subject distance of 1 mm to 3 mm can undergo image quality conversion to obtain an image having the optimum subject distance. In other words, with the machine learning model, it is also possible to perform image quality enhancement on even a blurred image having a subject distance different ±1.5 mm, for example, from the subject distance in the learning image used at the time of machine learning.

In addition, by executing the image quality enhancement processing on the second captured image captured at the second subject distance (substantially 5 mm) by the second endoscope 310, an image quality enhanced inference image such as the first captured image CI2 captured at the optimum subject distance is generated by the first endoscope 410 which generates a captured image with a higher image quality than the second endoscope 310. In addition, by executing the image quality enhancement processing on the second captured image captured at the second subject distance (substantially 9 mm) by the second endoscope 310, an image quality enhanced inference image such as the first captured image CI3 captured at the optimum subject distance is generated by the first endoscope 410 which generates a captured image with a higher image quality than the second endoscope 310.

Even when adopting the configuration of the third modification described above, it is possible to obtain the effects similar to those of the above-described embodiment and the second modification.

Moreover, in the third modification, one trained model MD4 is generated by machine learning by using a plurality of sets of teaching data (first captured image CI1) and training data (simulation image SI1), a plurality of sets of teaching data (first captured image CI2) and training data (simulation image SI2), and a plurality of sets of teaching data (first captured image CI3) and training data (simulation image SI3).

Accordingly, in a case where the second endoscope 310 generates the second captured image at various second subject distances, it is possible to generate the image quality enhanced inference image with high accuracy from the second captured image using the trained model MD4 even with no acquisition of the second subject distance.

### Fourth Modification

FIGS. 16 and 17 are diagrams each illustrating a fourth modification of the embodiment. Specifically, FIG. 16 is a diagram corresponding to FIG. 3, and is a diagram illustrating the generation processing (step S1C) according to the fourth modification.

In addition to generating the simulation image SI1, the generation processing unit 130 according to the fourth modification generates a simulation image SI4 in the following.

When using the simulation image SI1 as training data, the simulation image SI4 is teaching data corresponding to the training data. The simulation image SI4 is a simulation image simulating a captured image captured at a predetermined subject distance by a third endoscope (not illustrated), which generates a captured image lower in image quality than the first captured image CI1 and higher in image quality than the second captured image generated by the second endoscope 310.

Specifically, the generation processing unit 130 according to the fourth modification performs, in step S1C, generation of the simulation image SI1 similarly to the above-described embodiment and generation of the simulation image SI4 as described below.

First, as illustrated in FIG. 16, the generation processing unit 130 according to the fourth modification performs image plane projection of a first captured image CI1 captured at a first subject distance (3 mm) by the first endoscope 410 to generate an optical image of the first endoscope 410 (step S1C6). Specifically, the generation processing unit 130 enlarges the first captured image CI1 at a predetermined magnification in vertical/horizontal directions to generate an optical image of the first endoscope 410.

After step S1C6, as illustrated in FIG. 16, the generation processing unit 130 according to the fourth modification reads, from the storage unit 120, a correction PSF (correction PSF(4)) corresponding to the first subject distance of the first captured image CI1 (step S1C7).

Here, the storage unit 120 stores image quality correction information (correction PSF(4)) as the correction PSF corresponding to the first subject distance (3 mm) and the predetermined subject distance of the third endoscope (not illustrated).

Here, the correction PSF(1) is calculated as follows.

The MTF1, which is the amount of blur (MTF) on an imaging plane of the optical system constituting the first endoscope 410 at the first subject distance (3 mm), is calculated by optical simulation based on the first subject distance (3 mm) and first lens configuration information regarding the optical system.

In addition, an MTF3, which is the amount of blur (MTF) on an imaging plane of the optical system constituting the third endoscope at a predetermined subject distance, is calculated by optical simulation based on the predetermined subject distance and third lens configuration information regarding the optical system.

Correction PSF(4) is image quality correction information for correcting the amount of blurring from MTF1 to MTF3, and is constituted with a two-dimensional filter, for example.

After step S1C7, as illustrated in FIG. 16, the generation processing unit 130 according to the fourth modification performs a convolution of the correction PSF(4) on the optical image generated in step S1C6 so as to correct a blur (image quality) of the optical image (first captured image) (step S1C7). With this operation, an optical image of the third endoscope is generated (step S1C8).

After step S1C8, as illustrated in FIG. 16, the generation processing unit 130 according to the fourth modification performs sampling (pixel thinning) on the optical image generated in step S1C8 to generate a simulation image SI4.

Subsequently, the generation processing unit 130 according to the fourth modification stores the simulation image SI4 (teaching data) and the simulation image SI1 (training data) as one set in the storage unit 120.

In the fourth modification, processing of the machine learning apparatus 200 (training processing unit 230) is also different from that of the above-described embodiment.

Specifically, as illustrated in FIG. 17, the training processing unit 230 according to the fourth modification repeatedly executes training processing (step S2B) on the learning model using a plurality of sets of teaching data (simulation image SI4) and training data (simulation image SI1), and generates the learning model that has undergone the training, as a trained model MD5. Subsequently, the training processing unit 230 stores the generated trained model MD5 in the storage unit 220.

That is, the training processing unit 230 according to the fourth modification acquires, in step S2A, a plurality of sets of teaching data (simulation image SI4) and training data (simulation image SI1).

The image processing method according to the fourth modification is similar to the above-described embodiment except that the trained model MD5 is used as a modification from the trained model MD. That is, in the fourth modification, by executing the image quality enhancement processing on the second captured image captured at the second subject distance (substantially 2 mm) by the second endoscope 310, an image quality enhanced inference image such as the captured image captured at a predetermined subject distance is generated by the third endoscope which generates a captured image with a higher image quality than the second endoscope 310.

Even when adopting the configuration of the fourth modification described above, it is possible to obtain the effects similar to those of the above-described embodiment.

In the fourth modification, when using the simulation image SI1 as training data, the simulation image SI4 is teaching data corresponding to the training data. The simulation image SI4 is generated as a simulation image simulating a captured image captured at a predetermined subject distance by a third endoscope (not illustrated), which generates a captured image lower in image quality than the first captured image CI1 and higher in image quality than the second captured image generated by the second endoscope 310. The fourth modification generates the trained model MD5 by machine learning using a plurality of sets of teaching data (simulation image SI4) and training data (simulation image SI1).

Therefore, the trained model MD5 is used to execute image quality enhancement processing on the second captured image captured by the second endoscope 310, making it possible to generate an image quality enhanced inference image such as a captured image captured at a predetermined subject distance by the third endoscope that generates a captured image having a higher image quality than the second endoscope 310. That is, there is no need to perform machine learning using a captured image captured by a target endoscope such as the third endoscope as teaching data, making it possible to generate an image quality enhanced inference image such as a captured image captured by the target endoscope without re-capturing a live image of the target endoscope.

### Fifth Modification

In the above-described embodiment, the first to third imaging apparatuses are constituted with the endoscope. However, the imaging apparatus is not limited thereto, and other imaging apparatuses may be adopted as long as the imaging apparatus generates a captured image by imaging.

### Sixth Modification

In the above-described embodiment, the PSF of the optical image (two-dimensional image) is corrected in generating the simulation image SI1, but the generation of the simulation image is not limited thereto. For example, simulation image SI1 may be generated by transforming the first captured image CI1 into a frequency space and correcting an Optical Transfer Function (OTF) in the frequency space.

According to the machine learning training data generation method, the machine learning method, the machine learning program, and the image processing apparatus according to the disclosure, it is possible to generate an image quality enhanced inference image with high accuracy.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A machine learning training data generation method comprising:
acquiring a first captured image generated by a first imaging apparatus and a first subject distance regarding the first captured image; and
correcting an image quality of the first captured image based on a conversion table to generate a simulation image as a machine learning training data corresponding to the first captured image defined as teaching data, the simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus.

2. The machine learning training data generation method according to claim 1, further comprising:
acquiring first imaging apparatus information regarding the first imaging apparatus associated with the first captured image; and
selecting the conversion table based on the first imaging apparatus information.

3. The machine learning training data generation method according to claim 2, further comprising acquiring, as the first imaging apparatus information, first lens configuration information regarding an optical system constituting the first imaging apparatus.

4. The machine learning training data generation method according to claim 1, wherein
the first subject distance is either a subject distance to an image center of the first captured image or a subject distance to a predetermined subject captured in the first captured image.

5. The machine learning training data generation method according to claim 1, further comprising generating a simulation image simulating a third captured image based on the conversion table, the third captured image being captured at a third subject distance by the second imaging apparatus.

6. A machine learning method comprising:
receiving a first captured image captured by a first imaging apparatus at a first subject distance;
correcting an image quality of the first captured image by using the first captured image based on a conversion table to generate a simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus;
setting a learning data set including teaching data formed with the first captured image and including training data formed with the simulation image; and
performing training processing with the learning data set.

7. The machine learning method according to claim 6, further comprising performing machine learning based on the conversion table, using as training data a simulation image simulating a third captured image captured at a third subject distance by the second imaging apparatus.

8. A non-transitory computer-readable recording medium with an executable machine learning program stored thereon, the program causing a computer to execute:
receiving a first captured image captured by a first imaging apparatus at a first subject distance;
correcting an image quality of the first captured image by using the first captured image based on a conversion table to generate a simulation image simulating a second captured image captured at a second subject distance by a second imaging apparatus configured to generate a captured image lower in image quality than the first captured image, the conversion table defining a correction amount from a correlation relationship between the first subject distance and the first imaging apparatus, and the second subject distance and the second imaging apparatus;
setting a learning data set including teaching data formed with the first captured image and including training data formed with the simulation image; and
performing training processing with the learning data set.
